(19) United States
(12) Patent Application Publication
(10) Pub. No.: US 2012/0098755 A1
(43) Pub. Date: Apr. 26, 2012

(54) TOUCH MODULE

(75) Inventors: JAO-CHING LIN, TAIEPI CITY (TW); LIN ABEL CHU, TAIPEI CITY (TW); CHUNG YI SHEN, TAINAN CITY (TW)

(73) Assignee: SENTELIC CORP., TAIPEI CITY (TW)

(21) Appl. No.: 12/911,875

(22) Filed: Oct. 26, 2010

(51) Int. Cl. G06F 3/041

(52) U.S. Cl. 345/173

(57) ABSTRACT

A touch module includes a touch layer, a transparent panel module and a case. The touch layer has at least one sensor and a connection circuit arranged at least partially around the sensor. The transparent panel module is bonded with one side of the touch layer to at least cover the sensor. The case is formed with an opening for receiving the transparent panel module, whereby the transparent panel module is at least partially exposed to outer side. An inner flange is formed along at least a part of the periphery of the opening for concealing where the connection circuit of the touch layer is positioned to achieve better interference protection effect and minimize the possibility of misjudgment and mis-touch.

### BACKGROUND OF THE INVENTION

1. Field of the Invention

The present invention relates generally to a touch module, and more particularly to a touch module with thinner thickness and better interference protection.

2. Description of the Related Art

Following the rapid development of information technologies and communication networks, electronic information products have more and more popularly used in various fields. The capacitive touch panel has become the mainstream of touch control technology. The capacitive touch panel is widely applied to various electronic information products such as cellular phones, laptop computers, walkmans, displays, monitors and AIO. The capacitive touch panel works on the principle that when a finger touches the capacitive touch panel, the capacitance will change to measure the displacement of the finger so as to achieve the object of operation/control.

FIGS. 1 and 1A show a conventional simple capacitive touch panel applied to an electronic product. The touch panel is mainly composed of a transparent panel 7 and a touch layer 8. The touch layer 8 includes a capacitive touch sensor 81 arranged at the center and a connection circuit 82 positioned along the periphery of the capacitive touch sensor 81. The connection circuit 82 is made of opaque conductive material (such as silver paste, molybdenum/aluminum/molybdenum, copper paste, etc.) In operation of the capacitive touch sensor 81, a display screen is generally used to show the respective operation sections of the capacitive touch sensor 81. A liquid crystal module layer 4 is additionally arranged under the capacitive touch sensor 81. Accordingly, the capacitive touch sensor 81 and the liquid crystal module layer 4 are visible through the transparent panel 7. In practice, the touch panel structure is generally positioned in a hollow of an opaque case 9. The touch layer 8 is affixed to the case 9 with an adhesive 83. The transparent panel 7 is directly exposed to outer side for an operator to directly touch the capacitive touch sensor 81 through the transparent panel 7. In the case that the opaque connection circuit 82 is visible through the transparent panel 7, the appearance and the sensing result of the electronic product will be affected. To overcome this problem, a colored (generally black) paint 71 is applied to the periphery of the transparent panel 7 to form a colored (black) frame for concealing the connection circuit 82. Under such circumstance, the connection circuit 82 will not be directly seen from outer side so as to keep a tidy appearance.

However, in practice, the above structure has the following shortcomings:
1. The colored paint 71 is applied to the periphery of the transparent panel 7 to form the colored frame for concealing the connection circuit 82. This process complicates the manufacturing procedure and the paint 71 leads to increase of material cost.
2. The connection circuit 82 tends to produce noises to interfere with the operation when the finger touches the touch panel without isolation layer.
3. Except the colored frame, the surface of the transparent panel 7 is not provided with any means for distinguishing the position of the connection circuit 82. Therefore, in operation, an operator often mis-touches the connection circuit 82 to result in misjudgment.
4. The touch panel is bonded with the case 9 simply by means of the adhesive 83. Due to the seams along the periphery of the touch panel, the touch panel can be hardly waterproof-treated.

FIG. 2 shows another measure for concealing the connection circuit 82. A transparent sheet 91 is disposed on upper side of the hollow of the case 9 to cover the transparent panel 70. A colored paint 92 is applied to the periphery of the transparent sheet 91 to form a frame for at least covering and concealing where the connection circuit 82 is positioned. By means of the transparent sheet 91, a better waterproof effect can be achieved. However, the above structure still has some defects as follows:
1. The colored paint 92 is applied to the periphery of the transparent sheet 91 to form the frame for concealing the connection circuit 82. This process complicates the manufacturing procedure and the paint 92 leads to increase of material cost.
2. The transparent sheet 91 will increase the total thickness of the product.
3. It is hard to precisely locate and align the transparent panel 70 with the case 9.
4. The transparent sheet 91 will lead to incorrectness of the touch sensing signal and deterioration of transparency.

### SUMMARY OF THE INVENTION

It is therefore a primary object of the present invention to provide a touch module, which is manufactured without any paint-made frame, so that the manufacturing process is simplified and the cost for the material is lowered. In addition, the touch module has a tidy and beautified appearance.

It is a further object of the present invention to provide the above touch module in which the connection circuit is directly concealed by the case so that the touch module is protected from any interference of external signal. Only the section corresponding to the sensors is exposed to outer side of the case so that the possibility of misjudgment and mis-touch is minimized.

It is still a further object of the present invention to provide the above touch module, which has better waterproof effect and is free from the problem of alignment in assembling process. Also, the touch module has better connection strength.

To achieve the above and other objects, the touch module of the present invention includes a transparent panel module and a touch layer. The transparent panel module has a first side and a second side opposite to the first side. The first side has at least one first surface and at least one second surface. The first and second surfaces are positioned on different levels of the transparent panel module. The second side has a sensing section corresponding to and opposite to the first surface and a wiring section corresponding to and opposite to the second surface. The touch layer is at least composed of multiple transparent sensors and an opaque connection circuit electrically connected with the transparent sensors. The multiple transparent sensors are deployed on the sensing section, while the connection circuit is deployed on the wiring section.

In the above touch module, the transparent panel module at least includes a first transparent panel and a second transparent panel which overlapped. The first and second surfaces are formed on one side of the first transparent panel distal from the second transparent panel. The sensing section and the wiring section are disposed on one side of the second transparent panel distal from the first transparent panel.

In the above touch module, the transparent panel module at least includes a first transparent panel and a second transparent panel which overlapped. The first transparent panel has an area smaller than that of the second transparent panel, whereby when the first transparent panel is overlaid on the second transparent panel, at least an uncovered part of the second transparent panel is not covered by the first transparent panel. The first surface is formed on one side of the first transparent panel distal from the second transparent panel. The second surface is formed on the uncovered part of the second transparent panel. The sensing section and the wiring section are disposed on one side of the second transparent panel distal from the first transparent panel.

In the above touch module, the first side of the transparent panel module has multiple first surfaces, a second surface and at least one third surface adjacent to the first surfaces. The third surface at least partially extends between the first surfaces. The third surface is positioned on a level different from that of the first surfaces. The second side of the transparent panel module has multiple sensing sections respectively corresponding to the first surfaces, and a wiring section corresponding to the second surface.

In the above touch module, the first surfaces of the transparent panel module are sealed in multiple openings of the case of the touch module.

The present invention can be best understood through the following description and accompanying drawings, wherein:

### BRIEF DESCRIPTION OF THE DRAWINGS

FIG. 1 is a sectional view showing that a conventional touch panel is connected with a case;

FIG. 1A is a top view according to FIG. 1;

FIG. 2 is a sectional view showing that another type of conventional touch panel is connected with a case;

FIG. 3 is a plane exploded view of a first embodiment of the present invention;

FIG. 3A is a sectional assembled view of the first embodiment of the present invention;

FIG. 3B is a top view according to FIG. 3A;

FIG. 4 is a sectional assembled view of a second embodiment of the present invention;

FIG. 5 is a sectional assembled view of a third embodiment of the present invention;

FIG. 6 is a plane exploded view of a fourth embodiment of the present invention;

FIG. 6A is a sectional assembled view of the fourth embodiment of the present invention;

FIG. 7 is a sectional assembled view of a fifth embodiment of the present invention;

FIG. 8 is a sectional assembled view of a sixth embodiment of the present invention; and

FIG. 9 is a top view of a seventh embodiment of the present invention.

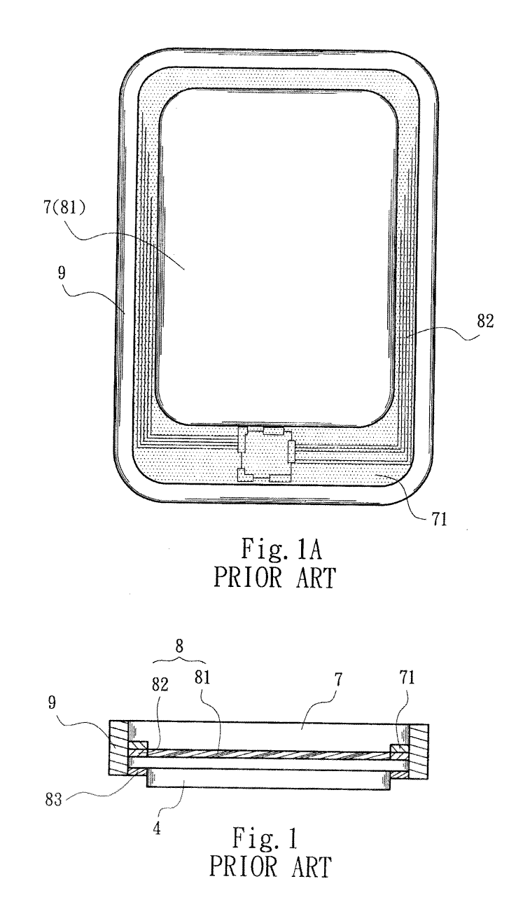

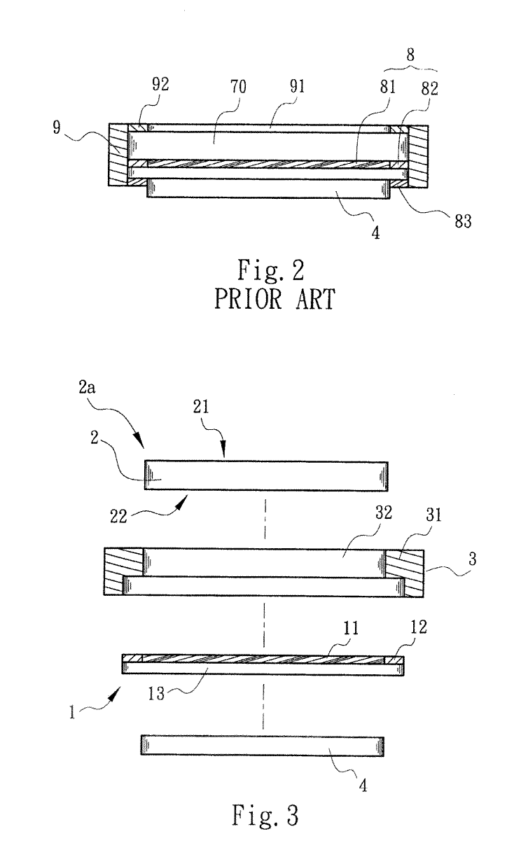

### DETAILED DESCRIPTION OF THE PREFERRED EMBODIMENTS

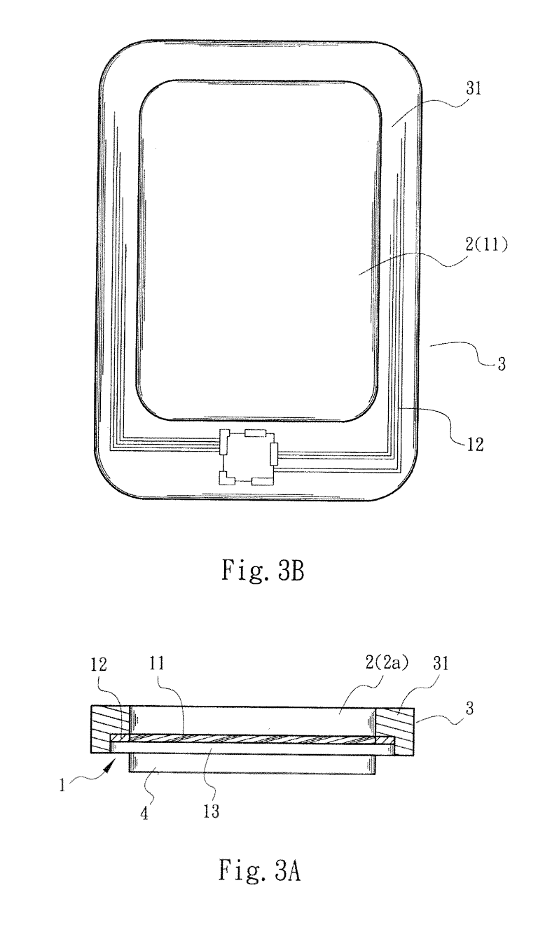

Please refer to FIGS. 3 to 3B. According to a first embodiment, the touch module of the present invention mainly includes a touch layer 1, a transparent panel module 2a and a case 3. The touch layer 1 is composed of multiple sensors 11 for sensing the touch and a connection circuit 12 arranged around the sensors 11. The multiple sensors 11 and the connection circuit 12 can be formed on a sheet-shaped transparent protective element 13 as necessary.

In this embodiment, the transparent panel module 2a is a one-piece transparent panel 2 made of transparent material. The transparent panel 2 has a first side 21 and a second side 22 opposite to the first side 21. The second side 22 is directly bonded with the sensors 11 of the touch layer 1. The connection circuit 12 is formed along at least a part of the periphery of the transparent panel 2. In practice, a liquid crystal module layer 4 is additionally disposed under the sensors 11 of the touch layer 1. The liquid crystal module layer 4 not only serves to display various images and information, but also serves to distinguish where the sensors 11 are touched. The touch layer 1 and the liquid crystal module layer 4 are combined with each other and visible from upper side through the transparent panel 2 for an operator to touch and operate the touch layer 1.

The case 3 is formed with an opening 32 for receiving the transparent panel 2, which is directly exposed to outer side. An inner flange 31 is formed along at least a part of the periphery of the opening 32 for directly concealing where the connection circuit 12 of the touch layer 1 is positioned. Accordingly, the connection circuit 12 of the touch layer 1 is prevented from being interfered with by external signals and the appearance can be beautified. In this case, only the sensors 11 are visible from the outer side of the case 3 through the transparent panel 2. This can minimize the possibility of misjudgment and interference of noises.

In practice, the transparent panel 2 can be previously processed, such as hardened or coated, as necessary. Then the transparent panel 2 is securely bonded with the case 3 by means of adhesion, press fit or mortise/tenon engagement.

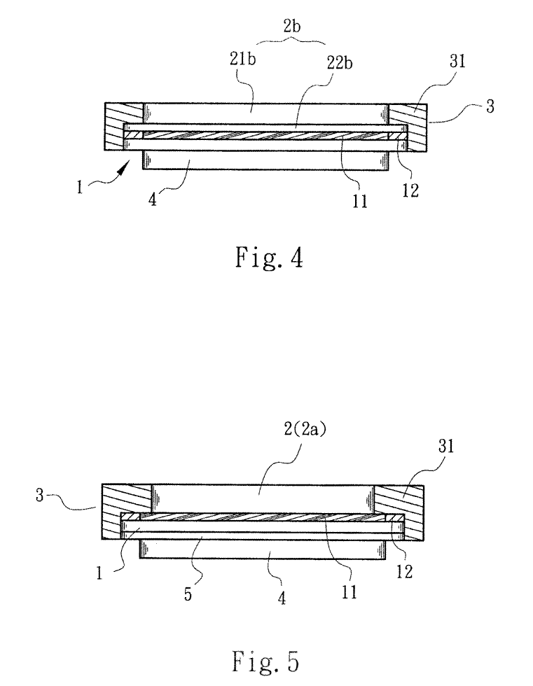

Please refer to FIG. 4, which shows a second embodiment of the present invention. According to the second embodiment, the touch module of the present invention includes a transparent panel module 2b, a touch layer 1 and a case 3 as in the first embodiment. The second embodiment is only different from the first embodiment in that the transparent panel module 2b is composed of a first transparent panel 21b and a second transparent panel 22b. The first transparent panel 21b corresponds to the sensors 11 of the touch layer 1 and is sealedly fixed in the opening 32 of the case 3. The second transparent panel 22b has an area larger than that of the first transparent panel 21b. When the first transparent panel 21b is overlaid on the second transparent panel 22b, at least an uncovered part of the second transparent panel 22b is not covered by the first transparent panel 21b. The uncovered part of the second transparent panel 22b correspondingly conceals the connection circuit 12 of the touch layer 1. The inner flange 31 of the case 3 conceals the uncovered part of the second transparent panel 22b. The other components of the touch layer 1, the case 3 and the relevant liquid crystal module layer 4 are totally identical to those of the first embodiment in structure and positional relationship.

Please refer to FIG. 5, which shows a third embodiment of the present invention. According to the third embodiment, the touch module of the present invention includes a touch layer 1, a transparent panel module 2a, a touch layer 1 and a case 3 as in the first embodiment.

The third embodiment further includes a magnetically conductive sheet-shaped grounding layer 5. The sensors 11 of the touch layer 1 are disposed beside an upper side of the liquid crystal module layer 4. The liquid crystal module layer 4 is a major source of electromagnetic wave that will vary and affect the capacitance of the sensors 11. To overcome this problem, in the third embodiment, the sheet-shaped grounding layer 5 is disposed between the touch layer 1 and the liquid crystal module layer 4 to shield the sensors 11 from the electromagnetic interference and ensure true measurement of the sensors 11.

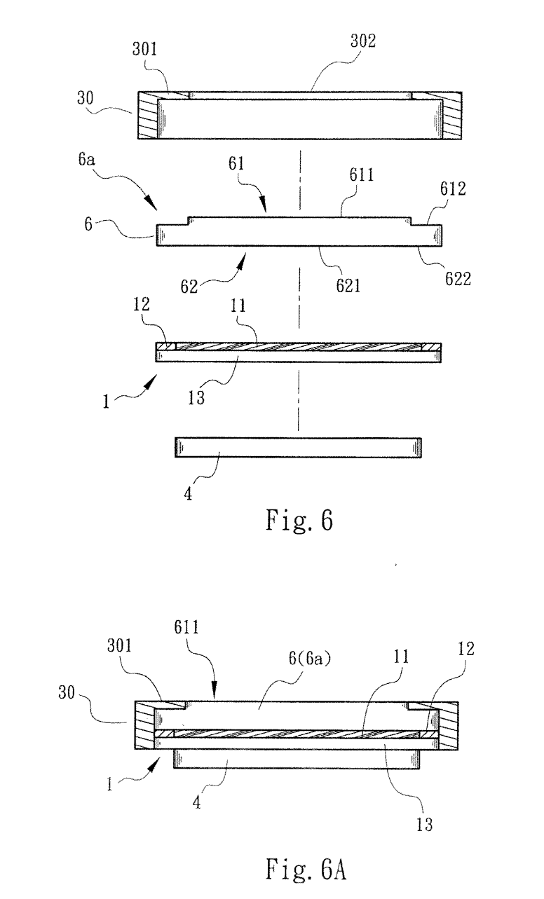

Please refer to FIGS. 6 and 6A, which show a fourth embodiment of the present invention. According to the fourth embodiment, the touch module of the present invention includes a touch layer 1 and liquid crystal module layer 4 as in the first embodiment. The fourth embodiment further includes a transparent panel module 6a and a case 30. In this embodiment, the transparent panel module 6a is a one-piece transparent panel 6 made of transparent material. The transparent panel 6 has a first side 61 and a second side 62 opposite to the first side 61. The first side 61 includes at least one first surface 611 and at least one second surface 612. The first and second surfaces 611, 612 are positioned on different levels of the transparent panel 6. The second side 62 has a sensing section 621 corresponding to and opposite to the first surface 611 and a wiring section 622 corresponding to and opposite to the second surface 612. The sensing section 621 and the wiring section 622 of the second side 62 of the transparent panel 6 are respectively directly bonded with the sensors 11 and the connection circuit 12 of the touch layer 1. The liquid crystal module layer 4 is disposed under the sensors 11 of the touch layer 1 The case 30 has an opening 302 for receiving the transparent panel 6, which is directly exposed to outer side. An inner flange 301 is formed along at least a part of the periphery of the opening 302 for directly concealing the second surface 612, (that is, the connection circuit 12), so as to beautify the appearance, avoid misjudgment and avoid interference of any external noise.

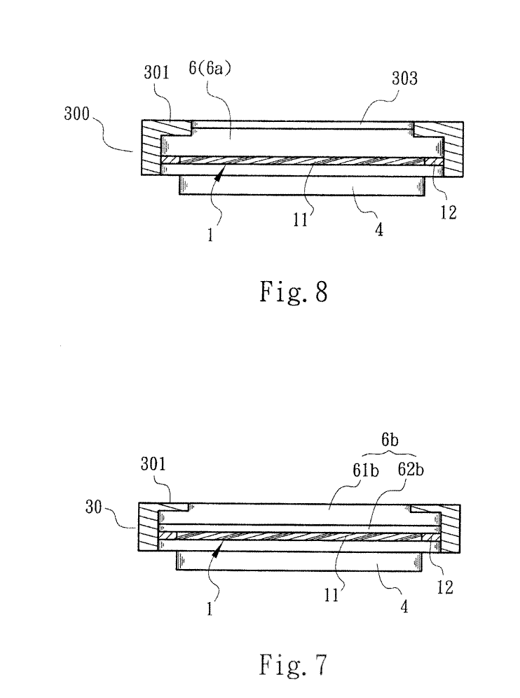

Please refer to FIG. 7, which show a fifth embodiment of the present invention. According to the fifth embodiment, the touch module of the present invention includes a touch layer 1, a case 30 and a liquid crystal module layer 4 as in the fourth embodiment. The fifth embodiment further includes a transparent panel module 6b. The fifth embodiment is only different from the fourth embodiment in that the transparent panel module 6b is composed of a first transparent panel 61b and a second transparent panel 62b. The first transparent panel 61b has the same configuration and structure as the transparent panel 6 and is fixed in the opening 302 of the case 30. The periphery of the second transparent panel 62b corresponds to the periphery of the first transparent panel 61b in shape and size. The second transparent panel 62b is sandwiched between the first transparent panel 61b and the touch layer 1. The other components of the touch layer 1, the case 3 and the relevant liquid crystal module layer 4 are totally identical to those of the fourth embodiment in structure and positional relationship.

Please refer to FIG. 8, which show a sixth embodiment of the present invention. According to the sixth embodiment, the touch module of the present invention includes a touch layer 1, a case 300, a liquid crystal module layer 4 and a transparent panel module 6a as in the fourth embodiment. The transparent panel module 6a (transparent panel 6) is fixed in the opening of the case 300. The other components of the touch layer 1 and the liquid crystal module layer 4 are totally identical to those of the fourth embodiment in structure and positional relationship. The sixth embodiment is only different from the fourth embodiment in that the sixth embodiment further includes a transparent sheet 303 disposed in the opening of the case 300 over the transparent panel module 6a. The transparent sheet 303 serves as a protective shield in adaptation to the case 300 with a different configuration for achieving better waterproof protection.

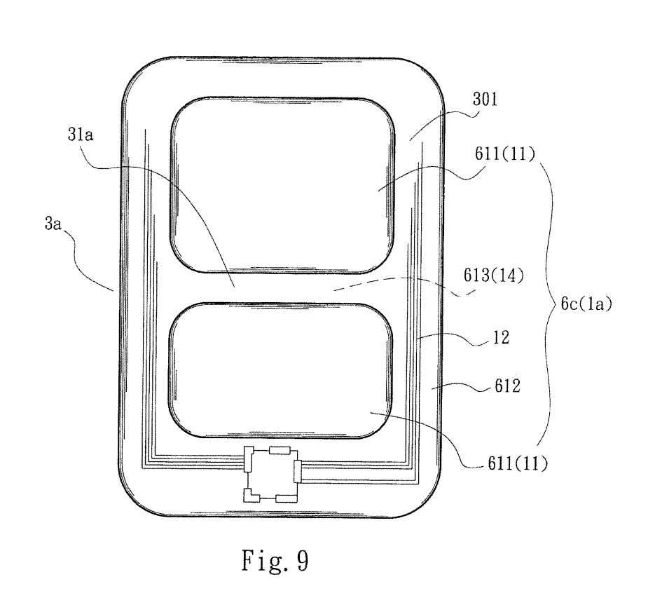

Please refer to FIG. 9, which show a seventh embodiment of the present invention. According to the seventh embodiment, the touch module of the present invention includes a touch layer la, a case 3a and a transparent panel module 6c. The touch layer la has multiple sensors 11 and at least one connection circuit 12 electrically connected with the sensors 11. A partitioning section 14 is arranged between the sensors 11. The transparent panel module 6c has a first side and a second side. The first side has multiple first surfaces 611, a second surface 612 and a third surface 613 respectively corresponding to the sensors 11, the connection circuit 12 and the partitioning section 14. The third surface 613 at least partially extends between the first surfaces 611. The third surface 613 is positioned on a level different from that of the first surfaces 611. The second side of the transparent panel module 6c has multiple sensing sections respectively corresponding to the first surfaces 611 and a wiring section corresponding to the second surface 612. The case 3a is formed with multiple openings respectively corresponding to the first surfaces 611 (sensors 11). A middle shade section 31a is formed between the openings corresponding to the third surface 613 (partitioning section 14). An inner flange 301 is formed along the periphery of each opening for concealing the second surface 612 (connection circuit 12). Accordingly, the electronic product has multiple groups of touch points.

According to the above arrangement, the inner flange 31 (301) of the case 3 (30) directly conceals the connection circuit 12 of the touch layer 1 to save the paint 71 (or 92) for forming the frame. Therefore, the manufacturing process is simplified and the cost for the material is saved. In practice, the case 3 (30) can be made of a magnetically conductive material. The inner flange 31 (301) of the case 3 (30) directly conceals the connection circuit 12 to avoid interference of any external signal. Moreover, only the position where the sensors 11 are located is exposed to outer side of the case 3 (30) for an operator to touch. Therefore, in operation, the situation of misjudgment due to mis-touch of the frame can be avoided. Furthermore, the inner flange 31 (301) of the case 3 (30) contacts the transparent panel 6 by larger area so that the problem of alignment in assembling process is eliminated. In addition, the inner flange 31 (301) provides better waterproof effect and stronger connection strength. Also, the product has a more beautiful appearance.

The transparent panel module 3a (6a) is mainly made of a transparent material easy to process, such as polymethylmethacrylate (PMMA or so-called acryl or organic glass), PET or strengthened plastics. Such material has higher mechanical strength than the conventional glass and has the advantages of easy processing and lighter weight.

In conclusion, the touch module of the present invention can be made by means of a simplified manufacturing process at lower material cost with beautified appearance.

The above embodiments are only used to illustrate the present invention, not intended to limit the scope thereof. Many modifications of the above embodiments can be made without departing from the spirit of the present invention.

What is claimed is:

1. A touch module comprising:
a transparent panel module having a first side and a second side opposite to the first side, the first side having at least one first surface and at least one second surface, the first and second surfaces being positioned on different levels of the transparent panel module, the second side having a sensing section corresponding to and opposite to the first surface and a wiring section corresponding to and opposite to the second surface; and
a touch layer at least composed of multiple transparent sensors and an opaque connection circuit electrically connected with the transparent sensors, the multiple transparent sensors being deployed on the sensing section, the connection circuit being deployed on the wiring section.

2. The touch module as claimed in claim 1, wherein the transparent panel module at least includes a first transparent panel and a second transparent panel which overlapped, the first and second surfaces being formed on one side of the first transparent panel distal from the second transparent panel, the sensing section and the wiring section being disposed on one side of the second transparent panel distal from the first transparent panel.

3. The touch module as claimed in claim 1, wherein the transparent panel module at least includes a first transparent panel and a second transparent panel which overlapped, the first transparent panel having an area smaller than that of the second transparent panel, whereby when the first transparent panel is overlaid on the second transparent panel, at least an uncovered part of the second transparent panel is not covered by the first transparent panel, the first surface being formed on one side of the first transparent panel distal from the second transparent panel, the second surface being formed on the uncovered part of the second transparent panel, the sensing section and the wiring section being disposed on one side of the second transparent panel distal from the first transparent panel.

4. The touch module as claimed in claim 1, wherein the first side of the transparent panel module has multiple first surfaces, a second surface and at least one third surface adjacent to the first surfaces, the third surface at least partially extending between the first surfaces, the third surface being positioned on a level different from that of the first surfaces, the second side of the transparent panel module having multiple sensing sections respectively corresponding to the first surfaces, and a wiring section corresponding to the second surface.

5. The touch module as claimed in claim 1, wherein the wiring section has an area not smaller than that of the connection circuit.

6. The touch module as claimed in claim 1, wherein the touch layer further includes a sheet-shaped transparent protective element, the multiple sensors and the connection circuit being disposed on the transparent protective element.

7. The touch module as claimed in claim 1, wherein a liquid crystal module layer is disposed on one side of the touch layer distal from the transparent panel module, a grounding layer with a grounding circuit being disposed between the liquid crystal module layer and the touch layer.

8. The touch module as claimed in claim 1, wherein the first surfaces of the transparent panel module are sealed in multiple openings of a case of the touch module.

9. The touch module as claimed in claim 4, wherein the first surfaces of the transparent panel module are sealed in multiple openings of a case of the touch module.

10. The touch module as claimed in claim 9, wherein a partitioning section is arranged between the sensors of the touch layer, a middle shade section being formed between the openings of the case corresponding to the partitioning section.

11. The touch module as claimed in claim 8, wherein the height difference between the first and second surfaces of transparent panel module is not larger than a thickness of the openings of the case.

12. The touch module as claimed in claim 8, wherein the transparent panel module is connected with the case by means of adhesion, press fit or mortise/tenon engagement.

13. The touch module as claimed in claim 1, wherein the transparent panel module is processed such as hardening or coating.

14. A touch module comprising:
a touch layer having multiple transparent sensors and a connection circuit arranged at least partially around the sensors;
a transparent panel module bonded with one side of the touch layer to at least cover the sensors of the touch layer; and
a case formed with an opening for receiving the transparent panel module, whereby the transparent panel module is at least partially exposed to outer side, an inner flange being formed along at least a part of a periphery of the opening for concealing where the connection circuit of the touch layer is positioned.

15. The touch module as claimed in claim 14, wherein the transparent panel module has a first side and a second side opposite to the first side, the second side having a sensing section corresponding to the sensors and a wiring section corresponding to the connection circuit, the first side having at least one first surface and at least one second surface corresponding to the sensing section and the wiring section respectively, the first and second surfaces being positioned on different levels of the transparent panel module.

16. The touch module as claimed in claim 14, wherein the transparent panel module is a one-piece transparent panel, the transparent panel having a thickness not smaller than a thickness of the opening of the case.

17. The touch module as claimed in claim 15, wherein the transparent panel module at least includes a first transparent panel and a second transparent panel which overlapped, the first transparent panel having an area smaller than that of the second transparent panel, whereby when the first transparent panel is overlaid on the second transparent panel, at least an uncovered part of the second transparent panel is not covered by the first transparent panel, the first surface being formed on one side of the first transparent panel distal from the second transparent panel, the second surface being formed on the uncovered part of the second transparent panel.

18. The touch module as claimed in claim 14, wherein the touch layer further includes a sheet-shaped transparent protective element, the multiple sensors and the connection circuit being disposed on the transparent protective element.

19. The touch module as claimed in claim 16, wherein the transparent panel has multiple sensing sections covered by the transparent panel, and at least one partitioning section arranged between the sensing sections.

20. The touch module as claimed in claim 19, wherein the first side of the transparent panel module has multiple first surfaces respectively corresponding to the sensing sections, and a third surface corresponding to the partitioning section, the third surface being positioned on a level different from that of the first surfaces.
